(19) United States
(12) Patent Application Publication
(10) Pub. No.: US 2023/0260266 A1
(43) Pub. Date: Aug. 17, 2023

(54) CAMERA-RADAR DATA FUSION FOR EFFICIENT OBJECT DETECTION

(71) Applicant: Waymo LLC, Mountain View, CA (US)

(72) Inventors: Vasiliy Igorevich Karasev, San Francisco, CA (US); Jiakai Zhang, Fremont, CA (US); Alper Ayvaci, San Jose, CA (US); Hang Yan, Sunnyvale, CA (US); James Philbin, Palo Alto, CA (US)

(21) Appl. No.: 18/108,749

(22) Filed: Feb. 13, 2023

Related U.S. Application Data
(60) Provisional application No. 63/310,457, filed on Feb. 15, 2022.
(60) Provisional application No. 63/434,545, filed on Dec. 22, 2022.

(51) Int. Cl. G06V 10/80; G01S 13/86; G01S 7/41; G06V 20/58; G06V 10/82; G06V 10/77

(52) U.S. Cl. CPC G06V 10/806; G01S 13/867; G01S 7/417; G01S 7/412; G06V 20/58; G06V 10/82; G06V 10/7715

(57) ABSTRACT

A method includes obtaining, by a processing device, input data derived from a set of sensors associated with an autonomous vehicle (AV), extracting, by the processing device from the input data, a plurality of sets of features, generating, by the processing device using the plurality of sets of features, a fused bird's-eye view (BEV) grid. The fused BEV grid is generated based on a first BEV grid having a first scale and a second BEV grid having a second scale different from the first scale. The method further includes providing, by the processing device, the fused BEV grid for object detection.

### CROSS-REFERENCE TO RELATED APPLICATIONS

The application claims the benefit of U.S. Provisional Application 63/310,457, filed on Feb. 15, 2022 and entitled “END-TO-END PROCESSING IN AUTOMATED DRIVING SYTEMS”, and U.S. Provisional Application 63/434,545, filed on Dec. 22, 2022 and entitled “CAMERA-RADAR DATA FUSION FOR EFFICIENT OBJECT DETECTION”, the entire contents of which are incorporated by reference herein.

### TECHNICAL FIELD

The instant specification generally relates to systems and applications that detect and classify objects and, in particular, to autonomous vehicles and vehicles deploying driver assistance technology. More specifically, the instant specification relates to camera-radar data fusion for faster and more resource-efficient detection of objects, including but not limited to vehicles, pedestrians, bicyclists, animals, and the like.

### BACKGROUND

An autonomous (fully or partially self-driving) vehicle (AV) operates by sensing an outside environment with various electromagnetic (e.g., radar and optical) and non-electromagnetic (e.g., audio and humidity) sensors. Some autonomous vehicles chart a driving path through the environment based on the sensed data. The driving path can be determined based on Global Navigation Satellite System (GNSS) data and road map data. While the GNSS and the road map data can provide information about static aspects of the environment (buildings, street layouts, road closures, etc.), dynamic information (such as information about other vehicles, pedestrians, streetlights, etc.) is obtained from contemporaneously collected sensing data. Precision and safety of the driving path and of the speed regime selected by the autonomous vehicle depend on timely and accurate identification of various objects present in the driving environment and on the ability of a driving algorithm to process the information about the environment and to provide correct instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 is a diagram illustrating components of an example autonomous vehicle (AV), in accordance with some implementations of the present disclosure.

FIGS. 2A-2B are diagrams illustrating example architectures of a part of a perception system that is capable of efficient detection and classification of objects, in accordance with some implementations of the present disclosure.

FIG. 3 is a diagram illustrating an example method of generating a fused bird's-eye view (BEV) grid from multi-scale BEV grids, in accordance with some implementations of the present disclosure.

FIGS. 4A-4B illustrate example methods of implementing camera-radar data fusion to generate a fused bird's-eye view (BEV) grid for efficient object detection, in accordance with some implementations of the present disclosure.

FIGS. 5A-5B illustrate example methods of implementing a bird's-eye view (BEV) grid generated using camera-radar data fusion for efficient object detection, in accordance with some implementations of the present disclosure.

FIG. 6 depicts a block diagram of an example computer device capable of implementing camera-radar data fusion to generate a fused bird's-eye view (BEV) grid for efficient object detection, in accordance with some implementations of the present disclosure.

### SUMMARY

In one implementation, disclosed is a method that includes obtaining, by a processing device, input data derived from a set of sensors associated with an autonomous vehicle (AV), extracting, by the processing device from the input data, a plurality of sets of features, generating, by the processing device using the plurality of sets of features, a fused bird's-eye view (BEV) grid. The fused BEV grid is generated based on a first BEV grid having a first scale and a second BEV grid having a second scale different from the first scale. The method further includes providing, by the processing device, the fused BEV grid for object detection.

In another implementation, disclosed is a system that includes a memory and a processing device, operatively coupled to the memory, configured to obtain input data derived from a set of sensors associated with an autonomous vehicle (AV), extract, from the input data, a plurality of sets of features, generate, using the plurality of sets of features, a fused bird's-eye view (BEV) grid. The fused BEV grid is generated based on a first BEV grid having a first scale and a second BEV grid having a second scale different from the first scale. The processing device is further configured to provide the fused BEV grid for object detection.

In yet another implementation, disclosed is a non-transitory computer-readable storage medium having instructions stored thereon that, when executed by a processing device, cause the processing device to perform operations including obtaining input data derived from a set of sensors associated with an autonomous vehicle (AV). The set of sensors includes at least one camera and at least one radar, and the input data include a set of camera data obtained from the at least one camera and a set of radar data obtained from the at least one radar. The operations further include extracting, from the input data, a plurality of sets of features. The plurality of sets of features includes a set of camera data features generated from the set of camera data and a set of radar data features generated from the set of radar data. The operations further include generating, using the plurality of sets of features, a fused bird's-eye view (BEV) grid. The fused BEV grid is generated based on a first BEV grid having a first scale and a second BEV grid having a second scale different from the first scale. The operations further include providing the fused BEV grid for object detection.

### DETAILED DESCRIPTION

Although various implementations can be described below, for the sake of illustration, using autonomous driving systems and driver assistance systems as examples, it should be understood that the techniques and systems described herein can be used for tracking of objects in a wide range of applications, including aeronautics, marine applications, traffic control, animal control, industrial and academic research, public and personal safety, or in any other application where automated detection of objects is advantageous.

In one example, for the safety of autonomous driving operations, it can be desirable to develop and deploy techniques of fast and accurate detection, classification, and tracking of various road users and other objects encountered on or near roadways, such as road obstacles, construction equipment, roadside structures, and the like. An autonomous vehicle (as well as various driver assistance systems) can take advantage of a number of sensors to facilitate detection of objects in a driving environment and determine the motion of such objects. The sensors typically include radio detection and ranging sensors (radars), light detection and ranging sensors (lidars), digital cameras of multiple types, sonars, positional sensors, and the like. Different types of sensors provide different and often complementary benefits. For example, radars and lidars emit electromagnetic signals (radio signals or optical signals) that reflect from the objects and carry information allowing to determine distances to the objects (e.g., from the time of flight of the signals) and velocities of the objects (e.g., from the Doppler shift of the frequencies of the signals). Radars and lidars can cover an entire 360-degree view, e.g., by using a scanning transmitter of sensing beams. Sensing beams can cause numerous reflections covering the driving environment in a dense grid of return points. Each return point can be associated with the distance to the corresponding reflecting object and a radial velocity (a component of the velocity along the line of sight) of the reflecting object.

Some systems and methods of object identification and tracking use various sensing modalities, such as lidars, radars, cameras, etc., to obtain images of the environment. The images can then be processed by trained machine learning models to identify locations of various objects in the images (e.g., in the form of bounding boxes), state of motion of the objects (e.g., speed, as detected by lidar or radar Doppler effect-based sensors), object types (e.g., a vehicle or pedestrian), and so on. Motion of objects (or any other evolution, such as splitting of a single object into multiple objects) can be performed by creating and maintaining tracks associated with a particular object.

Using multiple sensing modalities (e.g., lidars, radars, cameras) to obtain often complementary data improves precision of object detection, identification, and tracking but comes at a substantial cost in sensing hardware and processing software. For example, a lidar sensor can provide valuable information about distances to various reflecting surfaces in the outside environment. A lidar sensor, however, is an expensive optical and electronic device that operates by actively probing the outside environment with optical signals and requires considerable maintenance and periodic calibration. Lidar returns (the point cloud) have to be processed, segmented into groups associated with separate hypothesized objects, and matched with objects detected using other sensing modalities (e.g., cameras), which requires additional processing and memory resources. Cameras, on the other hand, operate by passively collecting light (and/or infrared electromagnetic waves) emitted (or reflected) by objects of the environment and are significantly simpler and cheaper in design, installation, and operations. Consequently, various driver assistance systems that do not deploy lidars (for costs and maintenance reasons) are typically equipped with one or more cameras. Cameras can also be more easily installed at various stationary locations and used for traffic monitoring and control, public and private safety applications, and the like. Being based on optical or infrared imaging technology, cameras have certain advantages over radars, which, while allowing detection of distances to (and velocities of) objects, operate in a range of wavelengths that has intrinsically lower resolution compared with cameras. An ability to detect and identify objects based on camera-only images is, therefore, beneficial.

Cameras, however, produce projections of a three-dimensional (3D) outside environment onto a two-dimensional imaging surface (e.g., an array of camera's light detectors), which may be a plane or a curved surface. This gives rise to two related challenges. On one hand, distances to objects (often referred to depths of the objects in the image) are not immediately known (though can often be determined from the context of the imaged objects). On the other hand, camera images have perspective distortions causing the same number of pixels separating images of objects to correspond to different distances between objects depending on the depths of the objects. Additionally, objects whose depictions are proximate to each other can nonetheless be separated by a significant distance (e.g., a car and a pedestrian visible behind the car). Machine learning techniques of object detection sometimes attempt to map objects from the perspective view to the top-down view, also known as the bird's-eye view (BEV), in which objects are represented on a convenient manifold, e.g., a plane viewed from above and characterized by a simple set of Cartesian coordinates. Object identification and tracking can subsequently be performed directly within the BEV representation. Success of such techniques depends on accurate mapping of the objects to the BEV representation. This, in turn, can rely on precise estimates of distances to various objects since misplacing of the objects within the BEV representation can result not only in an error in ascertaining a distance to a road user but may also lead to a loss of important contextual information.

Aspects and implementations of the present disclosure address these and other challenges by enabling methods and systems that can implement camera-radar data fusion and multi-scale BEV grids. In particular, the disclosed techniques provide for an end-to-end perception model (EEPM) that can include a set of neural networks (NNs) trained to process input data from a set of sensors of an AV. For example, the input data can include camera data and radar data. The input data can be used to generate a fused BEV grid formed by fusing together a plurality of BEV grids. More particularly, at least two of the BEV grids can have a different scale (e.g., resolution and/or size). For example, a first BEV grid can have a first scale and a second BEV grid can have a second scale different from the first scale. Each BEV grid can be generated by transforming a respective set of features extracted from the input data into a respective set of points, and voxelizing the sets of points to generate the plurality of BEV grids. Accordingly, a BEV grid can also be referred to as a BEV voxel grid.

For example, a set of camera data features can be extracted from the camera data, and the set of camera data features can be transformed into a set of pixel points. Transforming the set of camera data features into the set of pixel points can include projecting three-dimensional (3D) camera data onto a two-dimensional (2D) space. As another example, a set of radar data features can be extracted from the radar data, and the set of radar data features can be transformed into a set of radar points. Transforming the set of radar data features into the set of radar points can include transforming a coordinate representation of the radar data. For example, if the radar data has a polar coordinate representation, the coordinate representation of the radar data can be transformed into a Cartesian coordinate representation.

The EEPM can be trained using sensor dropout scenarios, in which some of the sensors are removed or non-operational (e.g., at least one camera and/or at least one radar). For example, a right-side facing camera can be removed and the information about the objects in the portion of space covered by the right-side facing camera can be provided by other sensing modalities (e.g., lidar and/or radar sensors). Training scenarios can also include a complete dropout of a particular sensing modality, e.g., dropout of lidar data feed, such that all information about the environment is provided by cameras and radars. This trains the output of EEPM to be robust against failure of individual sensors and entire sensing modalities. Depending on computational complexity and sophistication of training, EEPM can be used in various levels of driving automation, including Level 2 driving assistance systems, Level 3 contextual autonomous driving, Level 4 predominantly autonomous driving, Level 5 fully autonomous driving, and other implementations.

Advantages of the described implementations include (but are not limited to) fast and accurate detection, identification, and tracking of objects in a way that avoids large computational overheads of processing of data of multiple sensing modalities. Since the machine learning models trained and deployed as disclosed herein are capable of efficient object detection based on input data (e.g., camera data and radar data), the EEPM models described herein can be deployed on a variety of platforms (e.g., AVs) including systems with modest computational resources.

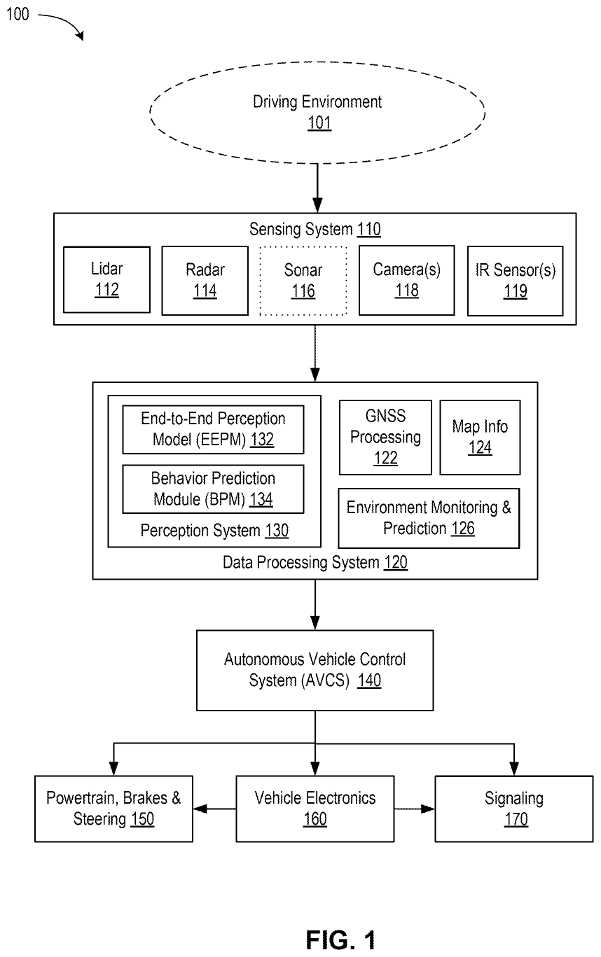

FIG. 1 is a diagram illustrating components of an example autonomous vehicle (AV) 100, in accordance with some implementations of the present disclosure. Autonomous vehicles can include motor vehicles (cars, trucks, buses, motorcycles, all-terrain vehicles, recreational vehicles, any specialized farming or construction vehicles, and the like), aircraft (planes, helicopters, drones, and the like), naval vehicles (ships, boats, yachts, submarines, and the like), spacecraft (controllable objects operating outside Earth atmosphere) or any other self-propelled vehicles (e.g., robots, factory or warehouse robotic vehicles, sidewalk delivery robotic vehicles, etc.) capable of being operated in a self-driving mode (without a human input or with a reduced human input).

Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

As described herein, in a semi-autonomous or partially autonomous driving mode, even though the vehicle assists with one or more driving operations (e.g., steering, braking and/or accelerating to perform lane centering, adaptive cruise control, advanced driver assistance systems (ADAS), or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods may be described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such driving assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

A driving environment 101 can include any objects (animate or inanimate) located outside the AV, such as roadways, buildings, trees, bushes, sidewalks, bridges, mountains, other vehicles, pedestrians, piers, banks, landing strips, animals, birds, and so on. The driving environment 101 can be urban, suburban, rural, and so on. In some implementations, the driving environment 101 can be an off-road environment (e.g., farming or other agricultural land). In some implementations, the driving environment 101 can be an indoor environment, e.g., the environment of an industrial plant, a shipping warehouse, a hazardous area of a building, and so on. In some implementations, the driving environment 101 can be substantially flat, with various objects moving parallel to a surface (e.g., parallel to the surface of Earth). In other implementations, the driving environment 101 can be three-dimensional and can include objects that are capable of moving along all three directions (e.g., balloons, falling leaves, etc.). Hereinafter, the term “driving environment” should be understood to include all environments in which an autonomous motion (e.g., SAE Level 5 and SAE Level 4 systems), conditional autonomous motion (e.g., SAE Level 3 systems), and/or motion of vehicles equipped with driver assistance technology (e.g., SAE Level 2 systems) can occur. Additionally, “driving environment” can include any possible flying environment of an aircraft (or spacecraft) or a marine environment of a naval vessel. The objects of the driving environment 101 can be located at any distance from the AV, from close distances of several feet (or less) to several miles (or more).

The example AV 100 can include a sensing system 110. The sensing system 110 can include various electromagnetic (e.g., optical, infrared, radio wave, etc.) and non-electromagnetic (e.g., acoustic) sensing subsystems and/or devices. The sensing system 110 can include one or more lidars 112, which can be a laser-based unit capable of determining distances to the objects and velocities of the objects in the driving environment 101. The sensing system 110 can include one or more radars 114, which can be any system that utilizes radio or microwave frequency signals to sense objects within the driving environment 101 of the AV 100. The lidar(s) 112 and or radar(s) 114 can be configured to sense both the spatial locations of the objects (including their spatial dimensions) and velocities of the objects (e.g., using the Doppler shift technology). Hereinafter, “velocity” refers to both how fast the object is moving (the speed of the object) as well as the direction of the object's motion. Each of the lidar(s) 112 and radar(s) 114 can include a coherent sensor, such as a frequency-modulated continuous-wave (FMCW) lidar or radar sensor. For example, lidar(s) 112 and/or radar(s) 114 can use heterodyne detection for velocity determination. In some implementations, the functionality of a ToF and coherent lidar (or radar) is combined into a lidar (or radar) unit capable of simultaneously determining both the distance to and the radial velocity of the reflecting object. Such a unit can be configured to operate in an incoherent sensing mode (ToF mode) and/or a coherent sensing mode (e.g., a mode that uses heterodyne detection) or both modes at the same time. In some implementations, multiple lidars 112 and/or radar 114s can be mounted on AV 100.

Lidar 112 (and/or radar 114) can include one or more optical sources (and/or radio/microwave sources) producing and emitting signals and one or more detectors of the signals reflected back from the objects. In some implementations, lidar 112 and/or radar 114 can perform a 360-degree scanning in a horizontal direction. In some implementations, lidar 112 and/or radar 114 can be capable of spatial scanning along both the horizontal and vertical directions. In some implementations, the field of view can be up to 60 degrees in the vertical direction (e.g., with at least a part of the region above the horizon being scanned with lidar or radar signals). In some implementations (e.g., aerospace applications), the field of view can be a full sphere (consisting of two hemispheres).

The sensing system 110 can further include one or more cameras 118 to capture images of the driving environment 101. Cameras 118 can operate in the visible part of the electromagnetic spectrum, e.g., 300-800 nm range of wavelengths (herein also referred for brevity as the optical range). Some of the optical range cameras 118 can use a global shutter while other cameras 118 can use a rolling shutter. The images can be two-dimensional projections of the driving environment 101 (or parts of the driving environment 101) onto a projecting surface (flat or non-flat) of the camera(s). Some of the cameras 118 of the sensing system 110 can be video cameras configured to capture a continuous (or quasi-continuous) stream of images of the driving environment 101. The sensing system 110 can also include one or more sonars 116, for active sound probing of the driving environment 101, e.g., ultrasonic sonars, and one or more microphones for passive listening to the sounds of the driving environment 101. The sensing system 110 can also include one or more infrared range (IR) sensors 119. For example, IR sensor(s) 119 can include an IR camera. IR sensor(s) 119 can use focusing optics (e.g., made of germanium-based materials, silicon-based materials, etc.) that is configured to operate in the range of wavelengths from microns to tens of microns or beyond. IR sensor(s) 119 can include a phased array of IR detector elements. Pixels of IR images produced by IR sensor(s) 119 can be representative of the total amount of IR radiation collected by a respective detector element (associated with the pixel), of the temperature of a physical object whose IR radiation is being collected by the respective detector element, or any other suitable physical quantity.

The sensing data obtained by the sensing system 110 can be processed by a data processing system 120 of AV 100. For example, the data processing system 120 can include a perception system 130. The perception system 130 can be configured to detect and track objects in the driving environment 101 and to recognize the detected objects. For example, the perception system 130 can analyze images captured by the cameras 118 and can be capable of detecting traffic light signals, road signs, roadway layouts (e.g., boundaries of traffic lanes, topologies of intersections, designations of parking places, and so on), presence of obstacles, and the like. The perception system 130 can further receive radar sensing data (Doppler data and ToF data) to determine distances to various objects in the environment 101 and velocities (radial and, in some implementations, transverse, as described below) of such objects. In some implementations, the perception system 130 can use radar data in combination with the data captured by the camera(s) 118, as described in more detail below.

The perception system 130 can include one or more components to facilitate detection, classification, and tracking of objects, including an end-to-end perception model (EEPM) 132 that can be used to process data provided by the sensing system 110. More specifically, in some implementations, EEPM 132 can receive data from sensors of different sensing modalities. For example, EEPM 132 can receive images from at least some of lidar(s) 112, radar(s) 114, and (optical range) camera(s) 118, IR sensor(s) 119, sonar(s) 116 and the like. In particular, EEPM 132 can include one or more trained machine-learning models (MLMs) that are used to process some or all of the above data to detect, classify, and track motion of various objects in the driving environment 101. EEPM 132 can use multiple classifier heads to determine various properties of the outside environment, including but not limited to occupation of space with various objects, types of the objects, motion of the objects, identification of objects that can be occluded, relation of the objects to the roadway, to other objects, and to the traffic flow. Various models of EEPM 132 can be trained using multiple sets of images/data, annotated to identify specific features in the respective sensing data. In some implementations, the perception system 130 can include a behavior prediction module (BPM) 134 that predicts future motion of the detected objects.

The perception system 130 can further receive information from a Global Navigation Satellite System (GNSS) positioning subsystem (not shown in FIG. 1), which can include a GNNS transceiver (not shown), configured to obtain information about the position of the AV relative to Earth and its surroundings. The positioning subsystem can use the positioning data, e.g., GNNS and inertial measurement unit (IMU) data in conjunction with the sensing data to help accurately determine the location of the AV with respect to fixed objects of the driving environment 101 (e.g., roadways, lane boundaries, intersections, sidewalks, crosswalks, road signs, curbs, surrounding buildings, etc.) whose locations can be provided by map information 124. In some implementations, the data processing system 120 can receive non-electromagnetic data, such as audio data (e.g., ultrasonic sensor data from sonar 116 or data from microphone picking up emergency vehicle sirens), temperature sensor data, humidity sensor data, pressure sensor data, meteorological data (e.g., wind speed and direction, precipitation data), and the like.

The data processing system 120 can further include an environment monitoring and prediction component 126, which can monitor how the driving environment 101 evolves with time, e.g., by keeping track of the locations and velocities of the animated objects (e.g., relative to Earth). In some implementations, the environment monitoring and prediction component 126 can keep track of the changing appearance of the environment due to a motion of the AV relative to the environment. In some implementations, the environment monitoring and prediction component 126 can make predictions about how various animated objects of the driving environment 101 will be positioned within a prediction time horizon. The predictions can be based on the current state of the animated objects, including current locations (coordinates) and velocities of the animated objects. Additionally, the predictions can be based on a history of motion (tracked dynamics) of the animated objects during a certain period of time that precedes the current moment. For example, based on stored data for a first object indicating accelerated motion of the first object during the previous 3-second period of time, the environment monitoring and prediction component 126 can conclude that the first object is resuming its motion from a stop sign or a red traffic light signal. Accordingly, the environment monitoring and prediction component 126 can predict, given the layout of the roadway and presence of other vehicles, where the first object is likely to be within the next 3 or 5 seconds of motion. As another example, based on stored data for a second object indicating decelerated motion of the second object during the previous 2-second period of time, the environment monitoring and prediction component 126 can conclude that the second object is stopping at a stop sign or at a red traffic light signal. Accordingly, the environment monitoring and prediction component 126 can predict where the second object is likely to be within the next 1 or 3 seconds. The environment monitoring and prediction component 126 can perform periodic checks of the accuracy of its predictions and modify the predictions based on new data obtained from the sensing system 110. The environment monitoring and prediction component 126 can operate in conjunction with EEPM 132. For example, the environment monitoring and prediction component 126 can track relative motion of the AV and various objects (e.g., reference objects that are stationary or moving relative to Earth).

The data generated by the perception system 130, the GNSS processing module 122, and the environment monitoring and prediction component 126 can be used by an autonomous driving system, such as AV control system (AVCS) 140. The AVCS 140 can include one or more algorithms that control how AV is to behave in various driving situations and environments. For example, the AVCS 140 can include a navigation system for determining a global driving route to a destination point. The AVCS 140 can also include a driving path selection system for selecting a particular path through the driving environment 101, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (rocks, stalled vehicles, and so on) within the driving environment of the AV. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

Algorithms and modules of AVCS 140 can generate instructions for various systems and components of the vehicle, such as the powertrain, brakes, and steering 150, vehicle electronics 160, signaling 170, and other systems and components not explicitly shown in FIG. 1. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions output by the AVCS 140 can be delivered directly to the powertrain, brakes, and steering 150 (or signaling 170) whereas other instructions output by the AVCS 140 are first delivered to the vehicle electronics 160, which generates commands to the powertrain, brakes, and steering 150 and/or signaling 170.

In one example, EEPM 132 can determine that images obtained by camera(s) 118 include depictions of an object and can further classify the object as a bicyclist. The environment monitoring and prediction component 126 can track the bicyclist and determine that the bicyclist is travelling with the speed of 15 mph along an intersecting road perpendicular to the direction of the motion of the vehicle. Responsive to such a determination, the BPM 134 can determine that the vehicle needs to slow down to let the bicyclist clear the intersection. The AVCS 140 can output instructions to the powertrain, brakes, and steering 150 (directly or via the vehicle electronics 160) to: (1) reduce, by modifying the throttle settings, a flow of fuel to the engine to decrease the engine rpm; (2) downshift, via an automatic transmission, the drivetrain into a lower gear; and (3) engage a brake unit to reduce (while acting in concert with the engine and the transmission) the vehicle's speed. After EEPM 132 and/or the environment monitoring and prediction component 126 determined that the bicyclist has crossed the intersection, the AVCS 140 can output instructions to the powertrain, brakes, and steering 150 to resume the previous speed settings of the vehicle.

The output of EEPM 132 can be used for tracking of detected objects. In some implementations, tracking can be reactive and can include history of poses (positions and orientations) and velocities of the tracked objects. In some implementations, tracking can be proactive and can include prediction of future poses and velocities of the tracked objects. In some implementations, future predictions can be generated by BPM 134, e.g., based at least partially on the output of EEPM 132. In some implementations, tracking-by-detection or instance segmentation can be used instead of building an explicit tracker. For example, an interface of BPM 134 can include, for each object, a history of recent object locations, extents, headings and velocities. In some implementations, flow information can be defined with reference to units of three-dimensional space (voxels). For additional accuracy of prediction, flow information associated with individual voxels can include not only velocities but also kinematic attributes, such as curvature, yaw rate, and the like. Based on this data, BPM 134 can predict future trajectories in a way that is advantageous over a more traditional tracking approach. In some implementations, an alternative approach can be used that deploys a recurrent neural network (RNN) to smooth and interpolate locations and velocities over time, which may be performed similarly to operations of a Kalman filter.

The output of EEPM 132 can be used for vehicle localization. In some implementations, BPM 134 can use lidar-based global mapping that maps an entire region of 3D environment around the vehicle. In some implementations, BPM 134 can deploy a simpler system that uses accelerometry, odometry, GNNS data, as well as camera-based lane mapping to identify the current position of the vehicle relative to the map data.

In different implementations, BPM 134 can have different levels of sophistication depending on the driving environment 101 (e.g., highway driving, urban driving, suburban driving, etc.). In L2 driving assistance implementations (“hands on the wheel”), where the driver is expected at any time to take over the vehicle's control, BPM 134 can have a minimum functionality and be able to predict behavior of other road users within a short time horizon, e.g., several seconds. For example, such predictions can include impeding lane changes by other vehicles (“agents”). BPM 134 can use various cues, such as a turning signal, front wheel turning, a driver turning the head in the direction of a turn, and the like. BPM 134 can determine if such impending lane changes require driver's attention. In the instances where a lane changing agent is sufficiently far from the vehicle, AVCS 140 acting on BPM 134 prediction can change the vehicle's trajectory (e.g., slow the vehicle down) without driver's involvement. In the instances where a change requires immediate driver's attention, BPM 134 can output a signal to the driver indicating that the driver should take over controls of the vehicle.

In L3 driving assistance implementations (“hands off the wheel”), the objective can be to provide an autonomous driving function for at least a certain time horizon (e.g., X seconds), such that if a condition arises that requires the driver's control, this condition will be predicted at least X seconds prior to its occurrence. The map data can further include camera and/or radar images of prominent landmarks (bridges, signs, roadside structures, etc.). In some implementations, BPM 134 of L3 systems may at any given time output two trajectories, Option A and a backup Option B, for X seconds. For example, when traveling on a city street in the rightmost lane of the street, BPM 134 can compute Option A for the vehicle to remain in the rightmost lane and can further compute Option B for the vehicle to move over to the left lane if a parked vehicle veers into the leftmost lane. BPM 134 can predict that within X seconds into the future the left lane is to remain available and continue vehicle operations. At some point, BPM 134 can predict that the left lane has a fast-moving agent that is to move close enough to the vehicle to make the left lane (and thus Option B) unavailable to the vehicle. Having determined that Option B is likely to become unavailable, BPM 134 can call the driver to take control of the vehicle. In yet even more sophisticated systems, where driver's input is not expected (e.g., autonomous L4 driving systems), if Option B disappears, AVCS 140 can stop the vehicle on the side of the road until the driving situation changes favorably.

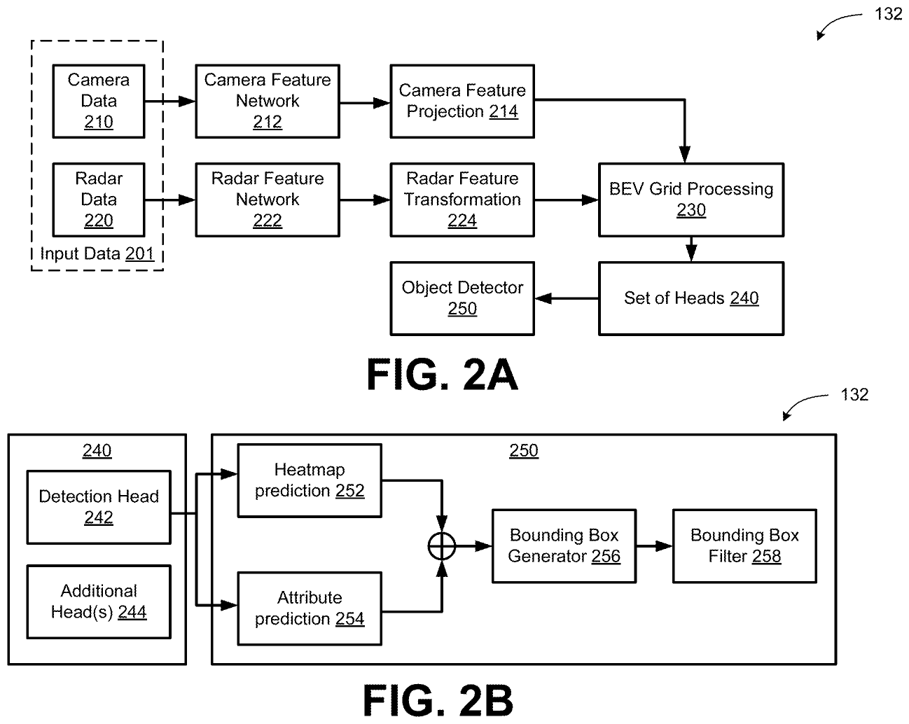

To achieve reliable predictions, BPM 134 can simulate multiple possible scenarios how different road users can behave in different ways and estimate the probability of various such scenarios and the corresponding outcomes. In some implementations, BPM 134 can use a closed-loop approach and determine a distribution of probabilities that, if the vehicle makes a certain driving path change (or maintains the current driving path), other vehicles are to respond in a certain way, e.g., to yield to the vehicle or to accelerate or otherwise block the vehicle's driving path. BPM 134 can evaluate multiple such scenarios and output probabilities for each or at least some of the scenarios. In some implementations, BPM 134 can use an open-loop approach, in which predictions are made based on the current state of motion of the agents and the changes of the motion of the vehicle do not affect the behavior of other agents. In some implementations, predicted locations of various agents can be represented via future occupancy heat maps. Further details regarding the EEPM 132 will now be described below with reference to FIGS. 2A-2B.

FIG. 2A is a diagram illustrating example network architecture of an end-to-end perception model (EEPM) 132 that can be deployed as part of a perception system of a vehicle, in accordance with some implementations of the present disclosure. Input data 201 can include data obtained by various components of the sensing system 110 (as depicted in FIG. 1), e.g., lidar(s) 112, radar(s) 114, optical (e.g., visible) range camera(s) 118, IR sensors (s) 119. For example, as shown, the input data 201 can include camera data 210 and radar data 220. Although not shown, the input data 201 can further include, e.g., lidar data.

The input data 201 can include images and/or any other data, e.g., voxel intensity, velocity data associated with voxels, as well as metadata, such as timestamps. The input data 201 can include directional data (e.g., angular coordinates of return points), distance data, and radial velocity data, e.g., as can be obtained by lidar(s) 112 and/or radar(s) 114. Additionally, the input data 201 can further include roadgraph data stored by (or accessible to) perception system 130, e.g., as part of map information 124. Roadgraph data can include any two-dimensional maps of the roadway and its surrounding, three-dimensional maps (including any suitable mapping of stationary objects, e.g., identification of bounding boxes of such objects). It should be understood that this list of input data 201 is not exhaustive and any suitable additional data can be used as part of input data 201, e.g., IMU data, GNNS data, and the like. Each of the modalities of input data 201 can be associated with a specific instance of time when the data was acquired. A set of available data (e.g., a lidar image, a radar image, a camera image, and/or an IR camera image, etc.) associated with a specific instance of time can be referred to as a sensing frame. In some implementations, the images obtained by different sensors can be synchronized, so that all images in a given sensing frame have the same (up to an accuracy of synchronization) timestamp. In some implementations, some images in a given sensing frame can have (controlled) time offsets.

An image obtained by any of sensors can include a corresponding intensity map I({xⱼ}) where {xⱼ} can be any set of coordinates, including three-dimensional (spherical, cylindrical, Cartesian, etc.) coordinates (e.g., in the instances of lidar and/or radar images), or two-dimensional coordinates (in the instances of camera data). Coordinates of various objects (or surfaces of the objects) that reflect lidar and/or radar signals can be determined from directional data (e.g., polar θ and azimuthal ϕ angles in the direction of lidar/radar transmission) and distance data (e.g., radial distance R determined from the ToF of lidar/radar signals). The intensity map can identify intensity of sensing signals detected by the corresponding sensors. Similarly, lidar and/or radar sensors can produce Doppler (frequency shift) map, Δf({xⱼ} that identifies radial velocity of reflecting objects based on detected Doppler shift d f of the frequency of the reflected radar signals, V=λΔf/2, where A is the lidar/radar wavelength, with positive values Δf>0 associated with objects that move towards the lidar/radar (and, therefore, the vehicle) and negative values Δf<0 associated with objects that move away from the lidar/radar. In some implementations, e.g., in driving environments where objects are moving substantially within a specific plane (e.g., ground surface), the radar intensity map and the Doppler map can be defined using two-dimensional coordinates, such as the radial distance and azimuthal angle: I(R, ϕ), Δf(R, ϕ).

A camera feature network 212 can receive the camera data 210 and extract a set of camera data features from the camera data 210. For example, the set of camera data features can include a set of camera data feature vectors. More specifically, a camera data feature can be a two-dimensional (2D) camera data feature. Camera data feature network 212 can use any suitable perspective backbone(s) to obtain the set of camera data features. Examples of suitable perspective backbones include Resnet, EfficientNet, etc. In some implementations, each camera sensor (e.g., front-facing camera, rear-facing camera, etc.) can use the same vision backbone (e.g., same shared weights) in training to avoid learning viewpoint-specific priors to avoid performance of EEPM 132 to be affected by vehicle yaws. Each camera data feature can be associated with a particular pixel or a cluster of pixels. Each pixel (or a cluster of pixels) may be associated with a respective depth distribution and a respective depth feature. In some implementations, the processed camera data can be downsampled for computational efficiency. In some implementations, pseudo-cameras can be used. Pseudo-cameras represent crops of the images from the full resolution images to provide finer detail for long range tasks. The pseudo-cameras can have a fixed crop or a crop that is driven from an output of the coarse resolution backbone. In some implementations, the crops can be trained directly. In some implementations, differentiable cropping can be used to train the attention mechanism end-to-end.

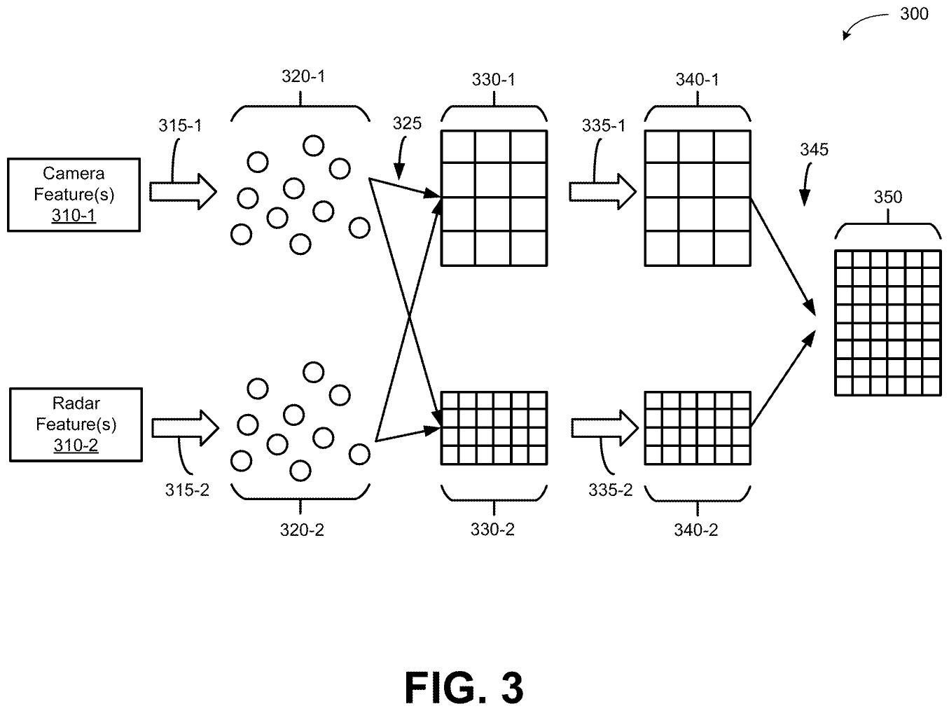

Camera data features can be provided to a camera data feature projection component 214. The camera data feature projection component 214 can utilize camera data feature projection to transform the set of camera data features into a set of pixel points. For example, the set of pixel points can be a pixel point cloud. In some implementations, utilizing camera data feature projection includes performing a lift transformation with respect to 2D camera data (e.g., from 2D backbones, sensor intrinsics and extrinsics (or derived intrinsics and extrinsics for pseudo-cameras)). To do so, the camera data feature transformation component 214 can project the 2D camera data to a three-dimensional (3D) space. This projection can be done using various depth distribution techniques. During training, depth ground truth can be available from other sensor data (e.g., lidar data) and can be used as a structured loss. Output of other sensors that can provide 2D images (e.g., IR cameras) can be processed using the same (or similar) architecture. Accordingly, the camera data feature projection component 214 can provide a lifted camera “context” combined across the cameras of the AV. Further details regarding generating the set of pixel points will be described below with reference to FIG. 3.

More specifically, the lift transformation can combine depth distributions and the set of camera features (e.g., feature vectors). As an illustrative example, the lift transformation can supplement each pixel w, h, described by a feature vector FV(c)_{w,h} with depth information from depth distributions. For example, the lift transformation can compute an outer product of each feature vector FV(c)_{w,h} (of dimensions C×1) with the corresponding depth distribution P(d)_{w,h} (of dimensions D×1) for the same pixel. The output of the lift transformation can be a feature that can be represented by, e.g., FV(c)_{w,h}⊗P(d)_{w,h}=FT(c, d)_{w,h} for pixel w, h.

Feature tensors FT (c, d)_{w,h} computed for individual pixels can then be used to obtain a combined feature tensor for the whole image, e.g., by concatenating feature tensors for different pixels: {FT(c, d)_{w,h}}→CFT(c, d, w, h). The combined feature tensor CFT(c, d, w, h) has dimensions C×D×W×H. The combined feature tensor can then undergo a 2D mapping. More specifically, 2D mapping can produce a projected feature tensor that uses a convenient set of plane coordinates, e.g., Cartesian coordinates x and y or polar coordinates r and θ within the plane of the ground.

2D mapping can be a two-part transformation. During the first part, perspective coordinates d, w, h can be transformed into 3D Cartesian coordinates d, w, h→x, y, z (or 3D cylindrical coordinates, w, h→r, θ, z), with z being the vertical coordinate (in the direction perpendicular to the ground). The transformation d, w, h→x, y, z can be a projective transformation, parameterized with a focal length of the camera, direction of the optical axis of the camera, and other similar parameters. In the instances where images are acquired by multiple cameras (or a camera with a rotating optical axis), the transformation d, w, h→x, y, z can include multiple projective transformations, e.g., with a separate transformation used for pixels w, h provided by different cameras.

During the second part, 2D mapping can project the combined feature tensor expressed in the new coordinates, CFT(c, x, y, z), onto a horizontal surface to obtain a projected (BEV) feature tensor. For example, to obtain the C×W×H projected feature tensor PCT (c, x, y), the combined feature tensor can be summed (or averaged) over elements associated with each vertical pillar of pixels, e.g., PCT (c, x, y)=ΣᵢCFT(c, x, y, zᵢ). In some implementations, the summation over coordinates zᵢ can be performed with different weights wᵢ assigned to different coordinates zᵢ: PCT(c, x, y)=Σᵢwᵢ×CFT(c, x, y, zᵢ), e.g., with larger weights wᵢ assigned to pixels that image objects within a certain elevations from the ground (e.g., up to several meters) and lower weights assigned to other elevations (e.g., to eliminate spurious objects, such as tree branches, electric cables, etc., that do not obstruct motion of vehicles). The projected feature tensor can characterize objects and their locations in the BEV in which perspective distortions have been reduced (e.g., eliminated).

A radar data feature network 222 can receive the radar data 220 and extract a set of radar data features from the radar data 220. For example, a radar data feature can be generated for each radar. Radar data feature network 222 can use any suitable radar backbone(s). Examples of suitable radar backbones include PointPillars, Range Sparse Net, etc. Each radar modality (e.g., intensity, second returns, Doppler shift, radar cross section) can have a different radar backbone and a feature generation layer. In some implementations, full periods (spins) of lidar/radar sensors can be used to obtain radar data features. In some implementations, portions of radar periods can be used to obtain radar data features. Processing of portions of such periods can allow EEPM 132 to react faster to new agents (e.g., vehicles, pedestrians, etc.) or sudden movements of existing agents in some cases and operate at the rate of the fastest sensor.

The set of radar data features can be provided to a radar data feature transformation component 224. The radar data feature transformation component 214 can utilize radar data feature transformation to transform the set of radar data features into a set of radar points. For example, the set of radar points can be a radar point cloud. Further details regarding generating the set of radar points will be described below with reference to FIG. 3.

The set of pixel points generated by the camera data feature projection component 214 and the set of radar points generated by the radar data feature transformation component 224 can be provided to a BEV grid processing component 230. The BEV grid processing component 230 can combine the set of pixel points and the set of radar points to generate a set of BEV grids. It may be the case that the set of radar data features have a coordinate representation that is not computationally efficient for integration into a BEV grid. Thus, in some implementations, performing the radar data feature transformation can include transforming the coordinate representation of the set of radar data features to a suitable coordinate representation for integration into a BEV grid. For example, a computationally efficient representation can be a Cartesian coordinate representation. Illustratively, the radar data feature network 222 can process the radar data 220 in a polar coordinate representation, and transforming the coordinate representation comprises transforming from the polar coordinate representation to the Cartesian coordinate representation.

Using the set of pixel points and the set of radar points to generate the set of BEV grids can include voxelizing the set of pixel points and the set of radar points to generate one or more BEV grids. In some implementations, the set of BEV grids includes a plurality of BEV grids.

In some implementations, the set of BEV grids defines a multi-scale BEV space, where each grid of the set of BEV grids is defined by a respective scale (e.g., resolution and/or size). The multi-scale BEV space is a shared feature space that can accumulate various available feature vector modalities. In some instances, a particular set of feature vectors (e.g., lidar features or roadgraph features) can be unavailable, temporarily or by design. In such instances, the respective contribution into multi-BEV space can be absent with EEPM 132 processing relying on other available features (e.g., camera and/or radar data features). The set of BEV grids defining the multi-BEV space can be recurrent, e.g., some proportion of the features obtained at time t₁ can be warped (using a differentiable warp such as a spatial transformer) and aggregated into new grids at time t₂ obtained together with the new features from time step t₂, e.g., using the smooth pose delta (i.e., pose change between time t₁ and time t₂). The multi-scale BEV space can be in a smooth pose consistent frame. The multi-scale BEV space can be spatially consistent for a period of time used for the aggregation in detection. In some implementations, a process for clearing distant portions of the grid and shifting values over as the AV moves through the world. Various priors in the global frame (e.g., elevation tiles, road graph) may undergo an accurate global-to-smooth transform. Dynamic objects may be represented using a flow field in combination with an occupancy map to perform additional recurrent aggregation. The multi-scale BEV space can be four-dimensional, with three spatial dimensions (e.g., 3D voxel space) and a time dimension. Each element of multi-scale BEV space can include a voxel, a time associated with this voxel, and a combined feature vector obtained by combining (e.g., concatenating) feature vectors output by various feature networks.

For example, the set of pixel points and the set of radar points can be voxelized to generate a first BEV grid defined by a first scale, and the set of pixel points and the set of radar points can be voxelized to generate a second BEV grid defined by a second scale different from the first scale. The first BEV grid can be a coarse BEV grid having a higher resolution (e.g., smaller voxel size) that can be used to detect objects closer to the AV, and the second BEV grid can be a fine BEV grid having a lower resolution (e.g., larger voxel size) for that can be used to detect objects further away from the AV. The sizes and/or resolutions of the BEV grids of the set of BEV grids can be dependent on the available computational facilities and specific driving missions, e.g., highway driving can involve grids with larger pixels (than in cases of urban driving) but extending to longer distances, proportional to the typical speeds involved. For example, even though fine BEV grids are more accurate than coarse BEV grids, coarse BEV grids can be used to reduce computational costs.

The BEV grid processing component 230 can further extract, for each BEV grid of the set of BEV grids, a respective set of BEV grid features. For example, the BEV grid processing component 230 can implement a set of BEV grid feature networks. Each BEV grid feature network of the set of BEV grid feature networks can extract, from a respective BEV grid of the set of BEV grids, the respective set of BEV grid features. Each BEV grid feature network can include any suitable number of layers for processing its respective BEV grid to extract the respective set of BEV grid features (e.g., layers implementing 3D convolutions in a ResNet-type architecture). For example, if the set of BEV grids includes the first BEV grid and the second BEV grid, then the set of BEV grid feature networks can include a first BEV grid feature network for extracting a first set of BEV grid features from the first BEV grid, and a second BEV grid feature network for extracting a second set of BEV grid features from the second BEV grid. The BEV grid processing component 230 can then resample each set of BEV grid features to its respective BEV grid to generate a resampled BEV grid. The BEV grid processing component 230 can then fuse each BEV grid together to generate a fused BEV grid. Further details regarding the set of BEV grids and the BEV grid processing component 230 will be described below with reference to FIG. 3.

The output of BEV grid processing component 230 (e.g., the fused BEV grid) can then be provided to a set of classifier heads (“heads”) 240. The set of heads 240 can include one or more heads that each generate a respective output. An output generated by at least one head of the set of heads 240 can be provided to an object detector 250. The object detector 250 can include one or more components to generate an object detection prediction based on the output(s) generated by the set of heads 240. If the set of BEV grids defines a multi-scale BEV space, then the scale of each BEV grid of the set of BEV grids can be handled in different ways, depending on a specific implementation. One approach can include cutting out, from the coarser scales, the voxel volume used by finer scales, so that one scale is used for various classification tasks. Such an approach can deploy special handling of voxels that are located in the vicinity of boundaries between different scales. Another option is to let each scale detect separately, then perform non-maximum suppression (NMS) over multiple scales. For example, one or more heads of the set of heads 240 can be allowed an access to multiple scales, when available. Yet another option can include enforcing sparsity in feature layers, implementing a threshold on a magnitude, and performing a sparse aggregation into a global voxel grid. Subsequent tasks can then use this sparse grid for inferences. Further details regarding the set of heads 240 and the object detector 250 will be described below with reference to FIG. 2B.

The EEPM 132 can include one or more additional feature networks (not shown). For example, the EEPM 132 can include a roadgraph feature network that can process roadgraph data and output roadgraph features that can include lanes and lane markings, road edges and medians, traffic lights and stop signs, crosswalks and speed bumps, driveways, parking lots and curb restrictions, railroad crossings, school zones, and zones inaccessible to traffic. Roadgraph features can be voxelized into coordinate frames. Roadgraph data can further include an elevation map. Such prior data can be treated as separate modalities. Such a framework can make it easier to incorporate new location-based data, such as a heatmap of object occurrences observed in previous runs. Roadgraph data can be accumulated during previous driving missions for a particular route. In some instances, where prior data is not available, roadgraph data can be limited by available map information 124 for a particular route. As with other modalities, roadgraph data can be missing, and during training EEPR 132 can be forced to learn to incorporate road graph data additively rather than rely on such data.

FIG. 2B illustrates an architecture of an EEPM 132 including the set of heads 240 and the object detector 250, in accordance with some implementations of the present disclosure. As shown, the set of heads 240 can include a detection head 242 and a set of additional heads 244.

The detection head 242 can be used to perform object detection. More specifically, the detection head 242 can classify boxes of voxels with emphasis on detecting objects. Examples of objects include agents (e.g., other vehicles), pedestrians, etc. In some implementations, the detection head 242 can further perform instance aggregation. Various approaches can be used that aggregate instances both over space and time such that a single detection or instance is a set of voxels xᵢ, yᵢ, zᵢ, tᵢ. In some implementations, a detection box approach can be used. More specifically, similar to the PointLens architecture, the detection head 242 can produce parameters for each box densely and then perform non-maximum suppression (NMS) or weighted aggregation to produce discrete detections. Each voxel can predict an existence probability, a center offset (dx, dy), a box extent (w, l), and a heading (which can be sin θ, cos θ). Although the detection box approach may not naturally allow the network to produce convex hulls, it is possible to use a Star-Poly type approach as an extension to accomplish this. In some implementations, the detection head 242 can further perform instance segmentation. In this approach, the network outputs dense per-instance occupancy. Such an approach can allow for convex hulls or even more general representations of object boundaries, which can be advantageous for articulated vehicles. For example, the segmentation approach can include the following operations: (i) produce a “centerness” output trained using a Gaussian that is close to the centroid of each object, (ii) produce an object center flow for each voxel within the object's bounds (dx, dy), (iii) find peaks in the centerness output using NMS, and (iv) associate voxels to each center using the center offset output masked using the occupancy map. Additional attributes can be aggregated using extra semantic heads and the voxel association. In some implementations, a signed distance field can be used. In this approach, the network can be trained to output a signed distance field representation. The network can then find zero crossings of this field plus containment to identify individual object instances (e.g., using a union-find algorithm). In some implementations, one or more of the described approaches can be combined.

Examples of heads of the set of additional heads 244 include a flow head, a segmentation head, an occupancy head, a semantics head, an occlusion head, a roadgraph head, etc. The flow head can output any suitable representation of flow (e.g., motion of objects) that corresponds to various voxels of space (e.g., using motion vectors or the like).

The occupancy head can determine whether voxels are occupied by an object. More specifically, the occupancy map gives a probability that a voxel location is inside an obstacle, e.g., similar to the probability-of-existence. The probability map can be used as a precursor data product to perform instance segmentation and other semantic inference tasks within the network.

The semantics head can be used to output the class of an object. For example, the semantics head can generate intent/semantics signals, including but not limited to such attributes as human poses, cyclist hand gestures, and the like. Various approaches to semantics tasks can be used depending on their quality bar. In one approach, a dense voxelized semantic layer can be deployed that uses the instance mask to look up and aggregate semantic signals. In another approach, a recurrent neural network can be deployed that uses instance location and extents to crop relevant features using region of interest (ROI) pooling from individual sensor backbones. This second approach can be advantageous for quality-critical tasks.

The occlusion head can output occlusion data related to an occluded object within the environment. For example, the occlusion data can include a probability that an occluded object exists at a location, a set of attributes of the occluded object (which can be conditioned on the occluded object being at the location), a probability that the occluded object would be perceived given the object's presence, etc. In some implementations, losses can be weighted using a probability-of-visibility mask to prevent the network to presciently guess properties about objects that the network should not be able to see.

The roadgraph head can output a reconstructed roadgraph in the vicinity of the vehicle based on a set of parameters. For example, the set of parameters can include voxel occupancy, flow of the motion of detected and classified objects, available map data, etc. The reconstructed roadgraph can be in a vectorized format (e.g., lanes represented as polylines) or a heat map format. In some implementations, the reconstructed roadgraph includes an association of various driving lanes to detected lights indicating whether the traffic is allowed to move in a particular lane. For example, a set of lights at an intersection can indicate that the rightmost lane has currently a green light that allows the right turn, two middle lines have red lights forbidding proceeding through the intersection in the forward direction, and the leftmost lane has a blinking yellow arrow indicating that the left turn is allowed provided that there is no oncoming traffic. The reconstructed roadgraph can be used to determine that the side of the street where the vehicle is located has four lanes and can further determine that the set of lights has four lights. The reconstructed roadgraph can include identification of the current statuses of each of the set of streetlights and the associations of each of the streetlights with the respective traffic lanes. Additionally, the reconstructed roadgraph can include the location of stop lines at the intersection.

Some of the heads of the set of heads 240 can be independent of additional heads of the set of heads 240, while some heads of the set of heads 240 can be interdependent of additional heads of the set of heads. For example, the detection head can be interdependent of at least the occupancy head, and the occupancy head can be interdependent of the semantics head.

In some implementations, the type of the object does not have to be determined and it can be sufficient to identify an occupancy grid (occupied and unoccupied voxels) and the flow (motion of the voxels) can be sufficient. For example, in highway driving use cases, identification of the type of an object can be less important than the fact that some object occupies a particular region of space (as all or most objects on the highways are vehicles). In urban driving use cases, identification of a type of an object can be more important as a much greater variety of road users can be present (e.g., pedestrians, electric scooters, bicyclists, dogs, etc.) each with a specific type of motion behavior (e.g., a pedestrian can be moving across a roadway).

As further shown, the object detector 250 can include a set of prediction components. Each prediction component of the set of prediction components can generate a respective prediction, forming a set of predictions. For example, the prediction components can include a heatmap prediction component 252 and an attribute prediction component 254. The heatmap prediction component 252 and the attribute prediction component 254 can each receive an output of at least the detection head 242 and generate heatmap prediction and an attribute prediction, respectively. Heatmap prediction values can represent the possibilities of an object appearing in the BEV grid. Examples of attribute predictions include object velocity predictions, vehicle lane association predictions (e.g., for telling which lane a vehicle is operating on), etc.

Each prediction of the set of predictions (e.g., the heatmap prediction and the attribute prediction) can be combined to obtain a combined prediction, and the combined prediction can be provided to a bounding box generator 256 to generate a set of candidate bounding boxes. Each candidate bounding box corresponds to a respective bounding box prediction for a corresponding object. More specifically, each candidate bounding box of the set of candidate bounding boxes describes a spatial location prediction of an object that is detected from the combined prediction. The set of candidate bounding boxes can include a single candidate bounding box for the object, or multiple overlapping candidate bounding boxes for the object.

The set of bounding box predictions can be provided to a bounding box filter 268 to select, as a bounding box for the object, an optimal candidate bounding box from the set of candidate bounding boxes. In some implementations, the bounding box filter 268 utilizes NMS. Accordingly, the object detector 250 can determine the most likely spatial location of an object based on a set of BEV grids generated from camera data and radar data.

FIG. 3 is a diagram 300 illustrating an example method of generating a fused BEV grid from multi-scale BEV grids, in accordance with some implementations of the present disclosure. The diagram 300 shows a set of camera data features 310-1 and a set of radar data features 310-2. The set of camera data features 310-1 can be extracted from camera data and the set of radar data features 310-2 can be extracted from radar data, as described above with reference to FIG. 2A.

At step 315-1, the set of camera data features 310-1 is transformed into a set of pixel points 320-1 using camera data feature projection. At step 315-2, the set of radar data features 310-2 is transformed into a set of radar points 320-2 using radar data feature transformation. For example, the set of pixel points 320-1 can be a pixel point cloud, and the set of radar points 320-2 can be a radar point cloud.

At step 325, the set of pixel points 320-1 and the set of radar points 320-2 are used to generate a BEV grid 330-1 and a BEV grid 330-2. More specifically, voxelization is performed to generate the BEV grids 330-1 and 330-2. The BEV grid 330-1 has a different size and/or resolution than the BEV grid 330-2. More specifically, the BEV grid 330-1 is a coarser grid and the BEV grid 330-2 is a finer grid.

At step 335-1, the BEV grid 330-1 is provided to a first BEV grid feature network of a set of BEV grid feature networks to extract a first set of BEV grid features, and the first set of BEV grid features is resampled to the BEV grid 330-1 to generate a resampled BEV grid 340-1. At step 335-2, the BEV grid 330-2 is provided to a second BEV grid feature network of the set of BEV grid feature networks to extract a second set of BEV grid features, and the second set of BEV grid features is resampled to the BEV grid 330-2 to generate a resampled BEV grid 340-2. Each BEV grid feature network can include any suitable number of layers for processing its respective BEV grid to extract the respective set of BEV grid features (e.g., layers implementing 3D convolutions in a ResNet-type architecture).

At step 345, the resampled BEV grids 340-1 and 340-2 are fused together to generate a fused BEV grid 350. The fused BEV grid 350 can then be provided to a set of heads (e.g., the set of heads 240 of FIGS. 2A-2B) for further processing (e.g., object detection using the object detector 250 of FIGS. 2A-2B). Further details regarding the diagram 300 are described above with reference to FIGS. 2A-2B.

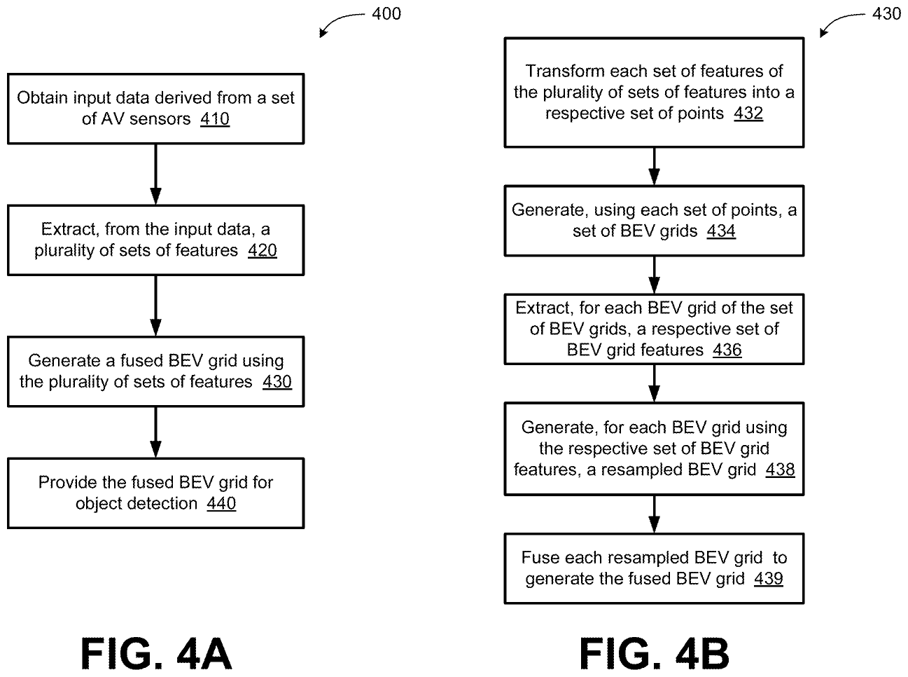

FIG. 4A is a flow diagram illustrating an example method of implementing camera-radar data fusion to generate a fused BEV grid for efficient object detection, in accordance with some implementations of the present disclosure. At least one processing device operatively coupled to memory can perform method 400 and/or each of their individual functions, routines, subroutines, or operations. For example, one or more processors can be communicably coupled to one or more memory devices. Examples of processors include central processing units (CPUs), graphics processing units (GPUs), tensor processing units (TPUs), application-specific integrated circuits (ASICs), field-programmable gate arrays (FPGAs), etc. A processing device executing method 400 can perform instructions issued by various components of the sensing system 110 or data processing system 120 of FIG. 1, e.g., EEPM 132. In some implementations, method 400 can be directed to systems and components of an autonomous driving vehicle, such as the autonomous vehicle 100 of FIG. 1. In some implementations, method 400 can be performed by EEPM 132, or any other similar model, which may be a part of a perception system of an autonomous vehicle, a vehicle that deploys driver assistance technology, or a part of any other application platform that uses object detection and classification.

Method 400 can be used to improve performance of the processing system 120 and/or the autonomous vehicle control system 140. In certain implementations, a single processing thread can perform method 400. Alternatively, two or more processing threads can perform method 400, each thread executing one or more individual functions, routines, subroutines, or operations of method 400. In an illustrative example, the processing threads implementing method 400 can be synchronized (e.g., using semaphores, critical sections, and/or other thread synchronization mechanisms). Alternatively, the processing threads implementing method 400 can be executed asynchronously with respect to each other. Various operations of method 400 can be performed in a different order compared with the order shown in FIG. 4A. Some operations of method 400 can be performed concurrently with other operations. Some operations can be optional.

At operation 410, processing logic obtains input data derived from a set of sensors. The set of sensors can be associated with an autonomous vehicle (AV). The input data can be obtained within a driving environment of the AV. For example, the input data can include camera data derived from at least one camera of the AV, and radar data derived from at least one radar of the AV. For example, the camera data can be based on real-time images obtained by one or more cameras of the AV, or by cameras mounted on any other suitable application platform. Cameras can be optical range cameras and/or IR cameras, including panoramic (surround-view) cameras, partially panoramic cameras, high-definition (high-resolution) cameras, close-view cameras, cameras having a fixed field of view (relative to the vehicle), cameras having a dynamic (adjustable) field of view, cameras having a fixed or adjustable focal distance, cameras having a fixed or adjustable numerical aperture, and any other suitable cameras. Optical range cameras can further include night-vision cameras. Images acquired by cameras can include various metadata that provides geometric associations between image pixels and spatial locations of objects, correspondence between pixels of different images, and the like.

At operation 420, processing logic extracts, from the input data, a plurality of sets of features. For example, the plurality of sets of features can include a set of camera data features extracted from the camera data and a set of radar features extracted from the radar data.

At operation 430, processing logic generates a fused BEV grid using the plurality of sets of features. More specifically, the fused BEV grid can be generated by fusing a plurality of BEV grids, where each BEV grid of the plurality of BEV grids is generated from the set plurality of sets of features. Each BEV grid of the plurality of BEV grids can have a respective scale (e.g., size and/or resolution). For example, a first BEV grid can have a coarser resolution than a second BEV grid. Further details regarding generating the fused BEV grid are described above with reference to FIGS. 2A-3 and will now be described below with reference to FIG. 4B.

FIG. 4B illustrates an example method 430 of generating a fused BEV grid, in accordance with some implementations of the present disclosure. At least one processing device operatively coupled to memory can perform method 430 and/or each of their individual functions, routines, subroutines, or operations. For example, one or more processors can be communicably coupled to one or more memory devices. Examples of processors include central processing units (CPUs), graphics processing units (GPUs), tensor processing units (TPUs), application-specific integrated circuits (ASICs), field-programmable gate arrays (FPGAs), etc. A processing device executing method 430 can perform instructions issued by various components of the sensing system 110 or data processing system 120 of FIG. 1, e.g., EEPM 132. In some implementations, method 430 can be directed to systems and components of an autonomous driving vehicle, such as the autonomous vehicle 100 of FIG. 1. In some implementations, method 430 can be performed by EEPM 132, or any other similar model, which may be a part of a perception system of an autonomous vehicle, a vehicle that deploys driver assistance technology, or a part of any other application platform that uses object detection and classification.

Method 430 can be used to improve performance of the processing system 120 and/or the autonomous vehicle control system 140. In certain implementations, a single processing thread can perform method 430. Alternatively, two or more processing threads can perform method 430, each thread executing one or more individual functions, routines, subroutines, or operations of method 430. In an illustrative example, the processing threads implementing method 430 can be synchronized (e.g., using semaphores, critical sections, and/or other thread synchronization mechanisms). Alternatively, the processing threads implementing method 430 can be executed asynchronously with respect to each other. Various operations of method 430 can be performed in a different order compared with the order shown in FIG. 4B. Some operations of method 430 can be performed concurrently with other operations. Some operations can be optional.

At operation 432, processing logic transforms each set of features of the plurality of sets of features into a respective set of points. In some implementations, each set of points is a point cloud. For example, the set of camera data features can be transformed into a set of pixel points and the set of radar data features can be transformed into a set of radar points.

For example, transforming the set of camera data features into a set of pixel points can include utilizing camera data feature projection. The camera data feature projection can include projecting 2D camera data features to a 3D space. In some implementations, utilizing camera data feature projection includes performing a lift transformation with respect to the 2D camera data features (e.g., from 2D backbones, sensor intrinsics and extrinsics (or derived intrinsics and extrinsics for pseudo-cameras)).

At operation 434, processing logic generates, using each set of points, a set of BEV grids. For example, the set of BEV grids can be generated using the set of pixel points and the set of radar points. More specifically, generating the set of BEV grids can include performing voxelization using each set of points. The set of BEV grids can include a first BEV grid and a second BEV grid. The first BEV grid can have a first scale (e.g., size and/or resolution) and the second BEV grid can have a second scale different from the first scale. Illustratively, the first BEV grid can be a coarser grid than the second BEV grid.

It may be the case that the set of radar data features have a coordinate representation not suitable for integration into a BEV grid. Thus, in some implementations, transforming the set of radar data features can include transforming the coordinate representation of the set of radar data features to a suitable coordinate representation for integration into a BEV grid. Transforming the set of radar features can include transforming from a polar coordinate representation to a Cartesian coordinate representation.

At operation 436, processing logic extracts, for each BEV grid of the set of BEV grids, a respective set of BEV grid features. For example, each BEV grid of the set of BEV grids can be provided to a respective BEV grid feature network to generate the respective set of BEV grid features.

At operation 438, processing logic generates, for each BEV grid using the respective set of BEV grid features, a resampled BEV grid. At operation 439, processing logic fuses each resampled BEV grid to generate the fused BEV grid. Further details regarding operations 432-439 are described above with reference to FIGS. 2A-3.

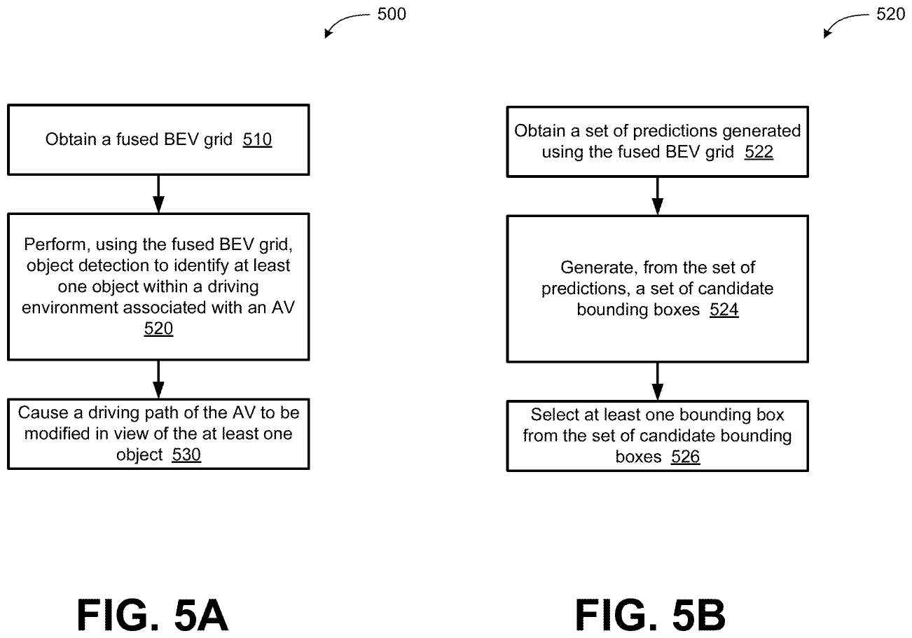

Referring back to FIG. 4A, at operation 440, processing logic can provide the fused BEV grid for object detection. For example, the fused BEV grid can be provided to an object detector. Object detection can be performed to identify at least one object within the driving environment of the AV. Further details regarding operations 410-440 are described above with reference to FIGS. 1-3. Further details regarding performing object detection will now be described below with reference to FIGS. 5A-5B.

FIG. 5A illustrates an example method 500 of implementing a BEV grid generated using camera-radar data fusion for efficient object detection, in accordance with some implementations of the present disclosure. At least one processing device operatively coupled to memory can perform method 500 and/or each of their individual functions, routines, subroutines, or operations. For example, one or more processors can be communicably coupled to one or more memory devices. Examples of processors include central processing units (CPUs), graphics processing units (GPUs), tensor processing units (TPUs), application-specific integrated circuits (ASICs), field-programmable gate arrays (FPGAs), etc. A processing device executing method 500 can perform instructions issued by various components of the sensing system 110 or data processing system 120 of FIG. 1, e.g., EEPM 132. In some implementations, method 500 can be directed to systems and components of an autonomous driving vehicle, such as the autonomous vehicle 100 of FIG. 1. In some implementations, method 500 can be performed by EEPM 132, or any other similar model, which may be a part of a perception system of an autonomous vehicle, a vehicle that deploys driver assistance technology, or a part of any other application platform that uses object detection and classification.

Method 500 can be used to improve performance of the processing system 120 and/or the autonomous vehicle control system 140. In certain implementations, a single processing thread can perform method 500. Alternatively, two or more processing threads can perform method 500, each thread executing one or more individual functions, routines, subroutines, or operations of method 500. In an illustrative example, the processing threads implementing method 500 can be synchronized (e.g., using semaphores, critical sections, and/or other thread synchronization mechanisms). Alternatively, the processing threads implementing method 500 can be executed asynchronously with respect to each other. Various operations of method 500 can be performed in a different order compared with the order shown in FIG. 5A. Some operations of method 500 can be performed concurrently with other operations. Some operations can be optional.

At operation 510, processing logic obtains a fused BEV grid. For example, the fused BEV grid can be generated by fusing multiple BEV grids each obtained from sets of features (e.g., a set of camera features and a set of radar features) in accordance with method 400 described above with reference to FIGS. 4A-4B.

At operation 520, processing logic performs, using the fused BEV grid, object detection to identifying at least one object within a driving environment associated with an AV. Further details regarding performing objection detection are described above with reference to FIGS. 2A-2B and will now be described below with reference to FIG. 5B.

FIG. 5B illustrates an example method 520 of performing object detection, in accordance with some implementations of the present disclosure. At least one processing device operatively coupled to memory can perform method 520 and/or each of their individual functions, routines, subroutines, or operations. For example, one or more processors can be communicably coupled to one or more memory devices. Examples of processors include central processing units (CPUs), graphics processing units (GPUs), tensor processing units (TPUs), application-specific integrated circuits (ASICs), field-programmable gate arrays (FPGAs), etc. A processing device executing method 520 can perform instructions issued by various components of the sensing system 110 or data processing system 120 of FIG. 1, e.g., EEPM 132. In some implementations, method 520 can be directed to systems and components of an autonomous driving vehicle, such as the autonomous vehicle 100 of FIG. 1. In some implementations, method 520 can be performed by EEPM 132, or any other similar model, which may be a part of a perception system of an autonomous vehicle, a vehicle that deploys driver assistance technology, or a part of any other application platform that uses object detection and classification.

Method 520 can be used to improve performance of the processing system 120 and/or the autonomous vehicle control system 140. In certain implementations, a single processing thread can perform method 520. Alternatively, two or more processing threads can perform method 520, each thread executing one or more individual functions, routines, subroutines, or operations of method 520. In an illustrative example, the processing threads implementing method 520 can be synchronized (e.g., using semaphores, critical sections, and/or other thread synchronization mechanisms). Alternatively, the processing threads implementing method 520 can be executed asynchronously with respect to each other. Various operations of method 520 can be performed in a different order compared with the order shown in FIG. 5B. Some operations of method 520 can be performed concurrently with other operations. Some operations can be optional.

At operation 522, processing logic obtains a set of predictions generated using the fused BEV grid. Each prediction of the set of predictions can be generated based on an output generated by a set of heads. For example, the set of heads can include a detection head and a set of other heads. Examples of heads that can be included in the set of other heads include a flow head, a segmentation head, an occupancy head, a semantics head, an occlusion head, a roadgraph head, etc. In some implementations, the set of predictions includes a heatmap prediction and an attribute prediction. The heatmap prediction and the attribute prediction can be generated from an output of at least the detection head.

At operation 524, processing logic generates, from the set of predictions, a set of candidate bounding boxes. Generating the set of candidate bounding boxes can include combining each prediction of the set of predictions to obtain a combined prediction, and generating the set of candidate bounding boxes using the combined prediction. Each candidate bounding box corresponds to a respective bounding box prediction for a corresponding object. More specifically, each candidate bounding box of the set of candidate bounding boxes describes a spatial location prediction of an object that is detected from the combined prediction. The set of candidate bounding boxes can include a single candidate bounding box for the object, or multiple overlapping candidate bounding boxes for the object.

At operation 526, processing logic selects a bounding box from the set of candidate bounding boxes. For example, the bounding box can be an optimal bounding box for the object. More specifically, the bounding box can correspond to a most likely spatial location of the object. Selecting the bounding box from the set of candidate bounding boxes can include applying a filter to the set of candidate bounding boxes. In some implementations, applying the filter to the set of candidate bounding boxes includes applying NMS. Further details regarding operations 522-526 are described above with reference to FIG. 2B.

Referring back to FIG. 5A, at operation 530, processing logic can cause a driving path of the AV to be modified in view of the at least one object. Further details regarding operations 510-530 are described above with reference to FIGS. 1-3.

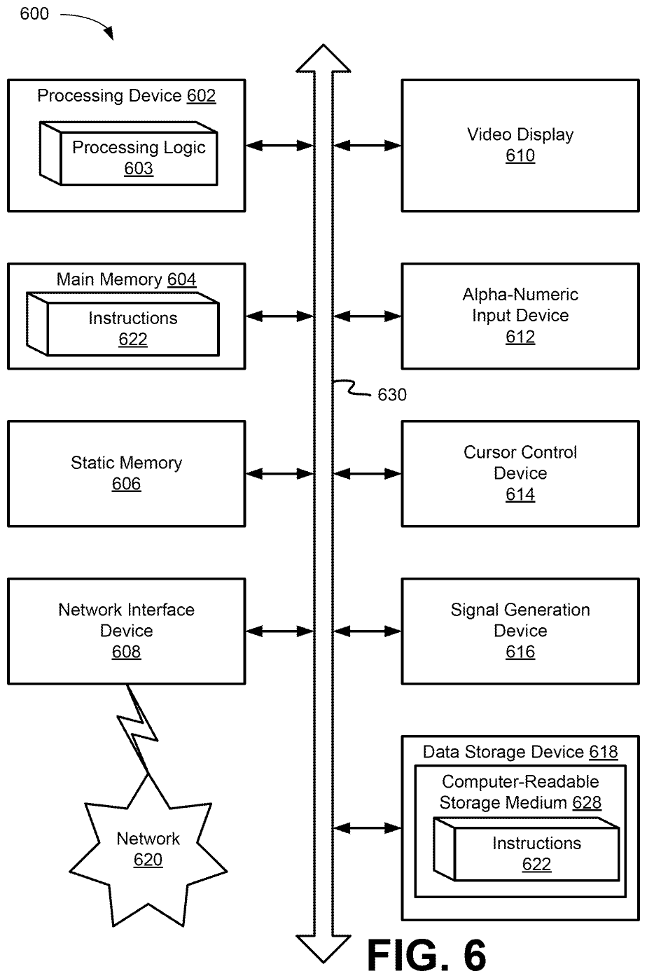

FIG. 6 depicts a block diagram of an example computer device 600 capable of implementing camera-radar data fusion to generate a fused BEV grid for efficient object detection, in accordance with some implementations of the present disclosure. Example computer device 600 can be connected to other computer devices in a LAN, an intranet, an extranet, and/or the Internet. Computer device 600 can operate in the capacity of a server in a client-server network environment. Computer device 600 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 600 can include a processing device 602 (also referred to as a processor or CPU), a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 618), which can communicate with each other via a bus 630.

Processing device 602 (which can include processing logic 603) represents one or more general-purpose processing devices such as a microprocessor, central processing unit, or the like. More particularly, processing device 602 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 602 can be configured to execute instructions performing method 400 and/or method 430 of FIGS. 4A-4B, and/or method 500 and/or method 520 of FIGS. 5A-5B.

Example computer device 600 can further comprise a network interface device 608, which can be communicatively coupled to a network 620. Example computer device 600 can further comprise a video display 610 (e.g., a liquid crystal display (LCD), a touch screen, or a cathode ray tube (CRT)), an alphanumeric input device 612 (e.g., a keyboard), a cursor control device 614 (e.g., a mouse), and an acoustic signal generation device 616 (e.g., a speaker).

Data storage device 618 can include a computer-readable storage medium (or, more specifically, a non-transitory computer-readable storage medium) 628 on which is stored one or more sets of executable instructions 622. In accordance with one or more aspects of the present disclosure, executable instructions 622 can comprise executable instructions performing method 400 and/or method 430 of FIGS. 4A-4B, and/or method 500 and/or method 520 of FIGS. 5A-5B.

Executable instructions 622 can also reside, completely or at least partially, within main memory 604 and/or within processing device 602 during execution thereof by example computer device 600, main memory 604 and processing device 602 also constituting computer-readable storage media. Executable instructions 622 can further be transmitted or received over a network via network interface device 608.

While the computer-readable storage medium 628 is shown in FIG. 6 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “obtaining,” “generating,” “providing,” “causing,” “transforming,” “fusing,” “selecting,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method comprising:
obtaining, by a processing device, input data derived from a set of sensors associated with an autonomous vehicle (AV);
extracting, by the processing device from the input data, a plurality of sets of features;
generating, by the processing device using the plurality of sets of features, a fused bird's-eye view (BEV) grid, wherein the fused BEV grid is generated based on a first BEV grid having a first scale and a second BEV grid having a second scale different from the first scale; and
providing, by the processing device, the fused BEV grid for object detection.

2. The method of claim 1, wherein:
the set of sensors comprises at least one camera and at least one radar;
the input data comprises a set of camera data obtained from the at least one camera and a set of radar data obtained from the at least one radar; and
the plurality of sets of features comprises a set of camera data features generated from the set of camera data and a set of radar data features generated from the set of radar data.

3. The method of claim 1, wherein generating the fused BEV grid further comprises:
associating each set of features of the plurality of sets of features with a respective set of points;
generating, using each set of points, a set of BEV grids, the set of BEV grids comprising the first BEV grid and the second BEV grid;
extracting, for each BEV grid of the set of BEV grids, a respective set of BEV grid features;
generating, for each BEV grid of the set of BEV grids using the respective set of BEV grid features, a resampled BEV grid, wherein the first BEV grid is associated with a first resampled BEV grid and wherein the second BEV grid is associated with a second resampled BEV grid; and
fusing each resampled BEV grid to generate the fused BEV grid.

4. The method of claim 3, wherein associating each set of features of the plurality of sets of features with a respective set of points further comprises:
transforming a set of camera features of the plurality of sets of features into a set of pixel points; and
transforming a set of radar features of the plurality of sets of features into a set of radar points, including transforming from a polar coordinate representation to a Cartesian coordinate representation.

5. The method of claim 1, further comprising performing, by the processing device using the fused BEV grid, the object detection to identify at least one object using a set of neural networks.

6. The method of claim 5, wherein performing object detection further comprises:
obtaining a set of predictions generated using the fused BEV grid, wherein the set of predictions comprises a heatmap prediction and an attribute prediction;
generating, from the set of predictions, a set of candidate bounding boxes, each candidate bounding box of the set of candidate bounding boxes corresponding to the at least one object; and
selecting, from the set of candidate bounding boxes, at least one bounding box corresponding to the at least one object.

7. The method of claim 5, further comprising causing, by the processing device, a driving path of the AV to be modified in view of the at least one object.

8. A system comprising:
a memory; and
a processing device communicative coupled to the memory, the processing device configured to:
obtain input data derived from a set of sensors associated with an autonomous vehicle (AV);
extract, from the input data, a plurality of sets of features;
generate, using the plurality of sets of features, a fused bird's-eye view (BEV) grid, wherein the fused BEV grid is generated based on a first BEV grid having a first scale and a second BEV grid having a second scale different from the first scale; and
provide the fused BEV grid for object detection.

9. The system of claim 8, wherein:
the set of sensors comprises at least one camera and at least one radar;
the input data comprises a set of camera data obtained from the at least one camera and a set of radar data obtained from the at least one radar; and
the plurality of sets of features comprises a set of camera data features generated from the set of camera data and a set of radar data features generated from the set of radar data.

10. The system of claim 8, wherein, to generate the fused BEV grid, the processing device is further configured to:
associate each set of features of the plurality of sets of features with a respective set of points;
generate, using each set of points, a set of BEV grids, the set of BEV grids comprising the first BEV grid and the second BEV grid;
extract, for each BEV grid of the set of BEV grids, a respective set of BEV grid features;
generate, for each BEV grid of the set of BEV grids using the respective set of BEV grid features, a resampled BEV grid, wherein the first BEV grid is associated with a first resampled BEV grid and wherein the second BEV grid is associated with a second resampled BEV grid; and
fuse each resampled BEV grid to generate the fused BEV grid.

11. The system of claim 10, wherein, to associate each set of features of the plurality of sets of features with a respective set of points, the processing device is further configured to:
transform a set of camera features of the plurality of sets of features into a set of pixel points; and
transform a set of radar features of the plurality of sets of features into a set of radar points by transforming from a polar coordinate representation to a Cartesian coordinate representation.

12. The system of claim 8, wherein the processing device is further configured to perform, using the fused BEV grid, the object detection to identify at least one object using a set of neural networks.

13. The system of claim 12, wherein, to perform object detection, the processing device is further configured to:
obtain a set of predictions generated using the fused BEV grid, wherein the set of predictions comprises a heatmap prediction and an attribute prediction;
generate, from the set of predictions, a set of candidate bounding boxes, each candidate bounding box of the set of candidate bounding boxes corresponding to the at least one object; and
select, from the set of candidate bounding boxes, at least one bounding box corresponding to the at least one object.

14. The system of claim 12, wherein the processing device is further configured to cause a driving path of the AV to be modified in view of the at least one object.

15. A non-transitory computer-readable storage medium having instructions stored thereon that, when executed by a processing device, cause the processing device to perform operations comprising:
obtaining input data derived from a set of sensors associated with an autonomous vehicle (AV), wherein the set of sensors comprises at least one camera and at least one radar, and wherein the input data comprises a set of camera data obtained from the at least one camera and a set of radar data obtained from the at least one radar;
extracting, from the input data, a plurality of sets of features, wherein the plurality of sets of features comprises a set of camera data features generated from the set of camera data and a set of radar data features generated from the set of radar data;
generating, using the plurality of sets of features, a fused bird's-eye view (BEV) grid, wherein the fused BEV grid is generated based on a first BEV grid having a first scale and a second BEV grid having a second scale different from the first scale; and
providing the fused BEV grid for object detection.

16. The non-transitory computer-readable storage medium of claim 15, wherein generating the fused BEV grid further comprises:
associating each set of features of the plurality of sets of features with a respective set of points;
generating, using each set of points, a set of BEV grids, the set of BEV grids comprising the first BEV grid and the second BEV grid;
extracting, for each BEV grid of the set of BEV grids, a respective set of BEV grid features;
generating, for each BEV grid of the set of BEV grids using the respective set of BEV grid features, a resampled BEV grid, wherein the first BEV grid is associated with a first resampled BEV grid and wherein the second BEV grid is associated with a second resampled BEV grid; and
fusing each resampled BEV grid to generate the fused BEV grid.

17. The non-transitory computer-readable storage medium of claim 16, wherein associating each set of features of the plurality of sets of features with a respective set of points further comprises:
transforming the set of camera features into a set of pixel points; and
transforming the set of radar features into a set of radar points, including transforming from a polar coordinate representation to a Cartesian coordinate representation.

18. The non-transitory computer-readable storage medium of claim 16, wherein the operations further comprise performing, using the fused BEV grid, the object detection to identify at least one object using a set of neural networks.

19. The non-transitory computer-readable storage medium of claim 18, wherein performing object detection further comprises:
obtaining a set of predictions generated using the fused BEV grid, wherein the set of predictions comprises a heatmap prediction and an attribute prediction;
generating, from the set of predictions, a set of candidate bounding boxes, each candidate bounding box of the set of candidate bounding boxes corresponding to the at least one object; and
selecting, from the set of candidate bounding boxes, at least one bounding box corresponding to the at least one object.

20. The non-transitory computer-readable storage medium of claim 18, wherein the operations further comprise causing a driving path of the AV to be modified in view of the at least one object.
